(19) United States
(12) Patent Application Publication
(10) Pub. No.: US 2026/0215622 A1
(43) Pub. Date: Jul. 30, 2026

(54) WEDGE, WEDGE SYSTEM AND METHOD OF WEDGING

(71) Applicant: The Big Green Egg, Inc., Atlanta, GA (US)

(72) Inventor: David Morelock, Atlanta, GA (US)

(21) Appl. No.: 19/040,348

(22) Filed: Jan. 29, 2025

(51) Int. Cl. A47J 37/07

(52) U.S. Cl. CPC A47J 37/0786

(57) ABSTRACT

A wedge that allows a portion of a rotatable first object to be spaced from a fixed second object. The wedge has a first lower surface extending for a circumferential length of the wedge configured to matingly engage an upper edge of the second object. The wedge also has a second upper surface extending for the circumferential length of the wedge configured to matingly engage a lower edge of the first object. A heat-deflecting shield extends upward and away from the second upper surface at an obtuse angle relative to the second upper surface for a predetermined distance. The predetermined distance varies along the circumferential length of the wedge so that the heat-deflecting shield has a first distance at the front of the wedge, and a second distance at the rear of the wedge that is less than the first distance.

### FIELD OF THE INVENTION

The present invention relates generally to wedges for selectively holding a first object in a desired position relative to a second object. More specifically, the present invention relates generally to wedge devices, systems and methods that allow a portion of a rotatable first object to be spaced from a fixed second object, while allowing access to an interior chamber of the wedge, the first object, and/or the second object.

### Background of the Invention

Many common items and devices include a first portion rotatably coupled to a fixed second portion. For example, conventional barbeque grills comprise a fixed lower tub having an open upper end and a lid configured to matingly engage the open upper end to form an enclosed inner tub volume. In use, the lid must be selectively movable about and between a first position, in which the lid is matingly engaged with the open upper end to form the enclosed inner tub volume, and a second position in which the lid is repositioned or removed to allow a user access to the inner tub volume.

In the first position, the enclosed inner tub volume is inaccessible and a user is therefore unable to position an item, such as food to be cooked, in the inner tub volume. In the second position, at least a portion of the lid is rotated away from the tub a predetermined distance so that an item, such as food to be cooked can be positioned in the inner tub volume. With the lid in the second position, however, heat can escape through the gap formed between the lid and the tub. This loss of heat can lead to longer cook times, uneven cooking due to a temperature gradient in the inner tub and other cooking problems.

Accordingly, it is desirable to provide wedge devices, systems and methods for holding a rotatable first object in a desired position relative to a stationary second object such that the inner tub volume is accessible and heat loss can be minimized.

### SUMMARY

Presented herein are wedge devices, systems and methods that allow a portion of a rotatable first object to be spaced from a fixed second object. The first object can have a lower edge configured to matingly engage an upper edge of the second object. The first object can be rotatable about and between a first, closed position in which the lower edge of the first object engages the upper edge of the second object, and a second, open position in which a front of the first object is spaced from the second object a predetermined open distance.

In one aspect, the wedge can comprise a first lower surface extending for a circumferential length of the wedge. The first lower surface can be configured to matingly engage the upper edge of the second object. In another aspect, the wedge can further comprise a second upper surface extending for the circumferential length of the wedge. The second upper surface can be configured to matingly engage the lower edge of the first object. As can be appreciated then, the wedge can be positioned between the first object and the second object.

A heat-deflecting shield can extend upward and away from the second upper surface of the wedge at an obtuse angle relative to the second upper surface for a predetermined distance. In one aspect, the predetermined distance can vary along the circumferential length of the wedge. For example, the predetermined distance can be a first distance at the front of the wedge, and a second distance at the rear of the wedge that is less than the first distance.

An opening can be defined in a portion of the front of the wedge. In one aspect, the opening can have an opening width such that an interior volume of the wedge is accessible though the opening. That is, the opening can be sized and shaped so that a desired item can be selectively inserted through the opening into the interior volume.

In use, the first object can be rotated from the second, open position to a third, intermediate position in which the wedge is positioned between the first object and the second object. In the third, intermediate position, the upper surface of the wedge can matingly engage the lower edge of the first object. An item to be inserted into the interior volume can be inserted through the opening.

Also presented herein is a method to selectively hold a rotatable first object in a desired position relative to a stationary second object such that an interior chamber formed by the first object and the second object is accessible.

Also presented herein is a method for evenly cooking a desired food item in an open grill.

Related methods of operation are also provided. Other apparatuses, methods, systems, features, and advantages of the wedge will be or become apparent to one with skill in the art upon examination of the following figures and detailed description. It is intended that all such additional apparatuses, methods, systems, features, and advantages be included within this description, be within the scope of the wedge and be protected by the accompanying claims.

### DESCRIPTION OF THE FIGURES

FIG. 1 is a perspective view of a wedge device positioned on a second stationary object, with a first rotatable object in a second, open position, according to one aspect;

FIG. 2 is a perspective view of the wedge device of FIG. 1, showing the first rotatable object in third, intermediate position;

FIG. 3 is a perspective view of the wedge device of FIG. 1, according to one aspect;

FIG. 4 is a front elevational view of the wedge device of FIG. 1, according to one aspect;

FIG. 5 is a rear elevational view of the wedge device of FIG. 1, according to one aspect;

FIG. 6 is a side elevational view of the wedge device of FIG. 1, according to one aspect; and

FIG. 7 is a top plan view of the wedge device of FIG. 1, according to one aspect.

### DESCRIPTION OF THE INVENTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to an “element” includes aspects having two or more such elements unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint and independently of the other endpoint.

As used herein, the terms “optional” or “optionally” mean that the subsequently described event or circumstance may or may not occur, and that the description includes instances where said event or circumstance occurs and instances where it does not.

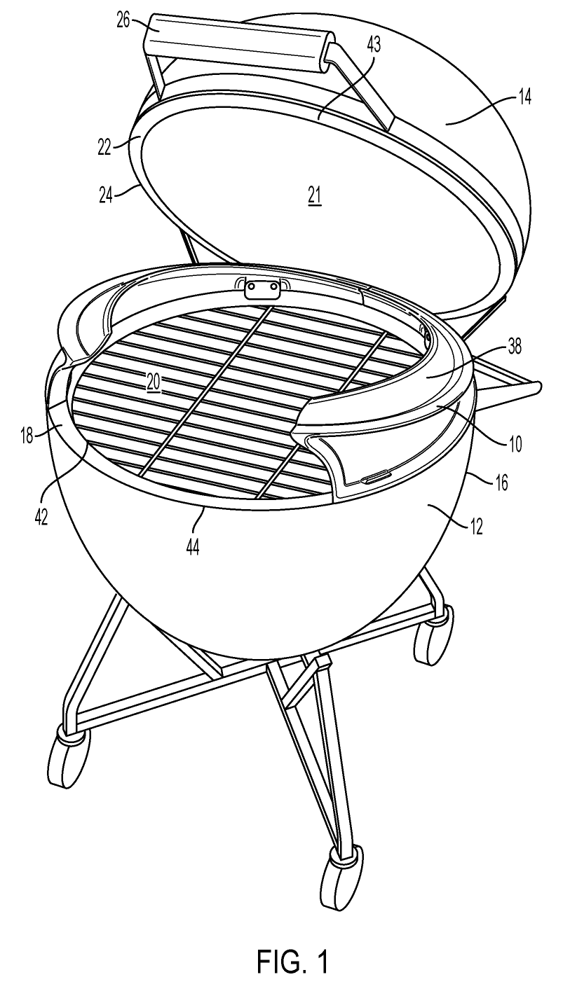

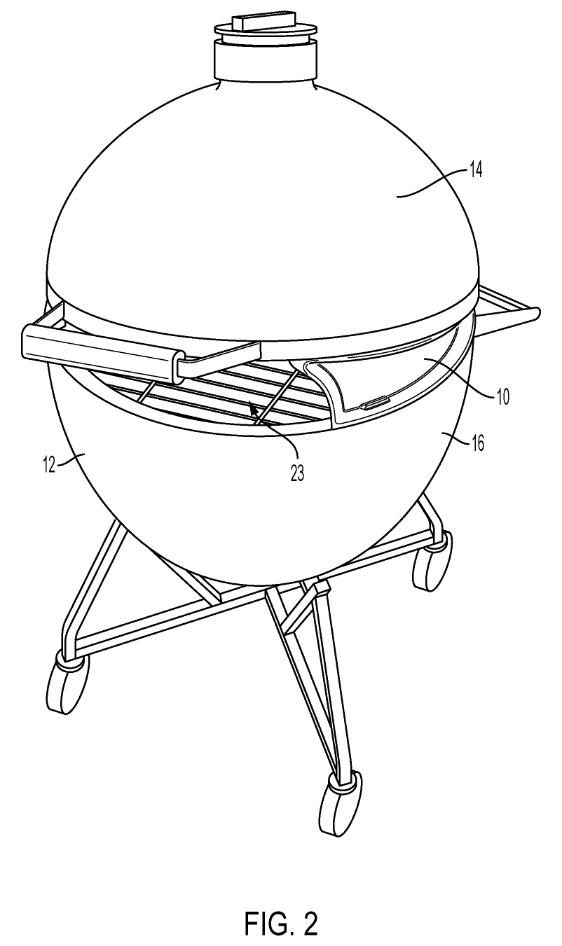

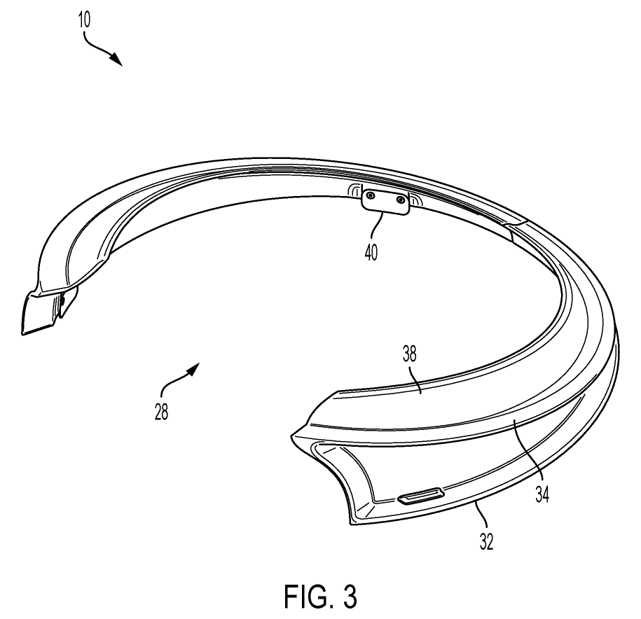

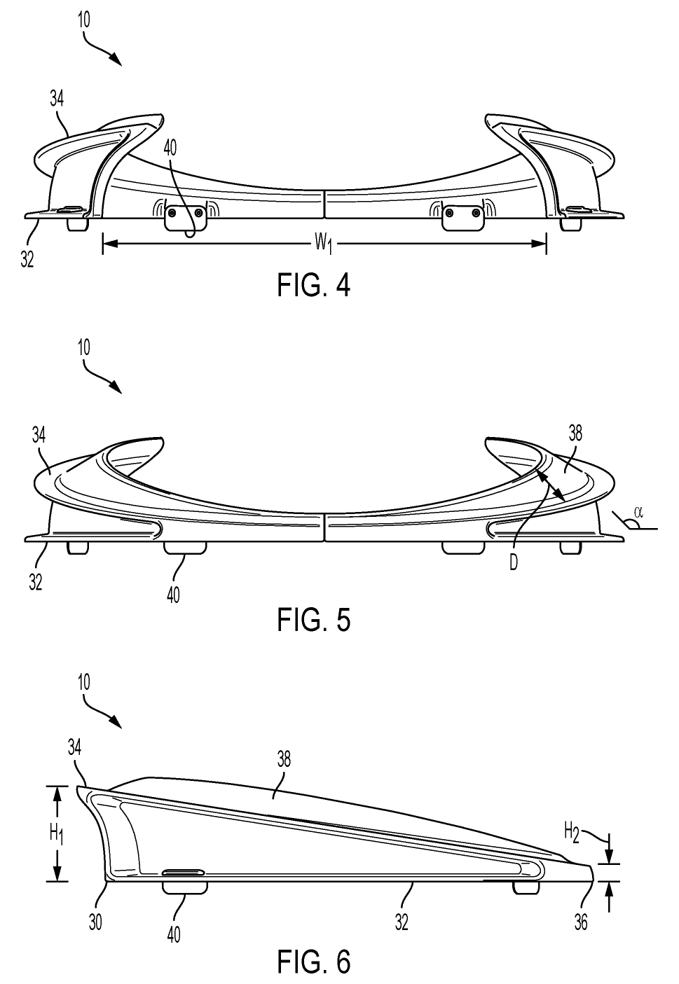

The wedge device that allows the selective holding of a rotatable first object in a desired position relative to a stationary second object is shown in FIGS. 1-7. Note that while reference will be made herein to the use of the wedge device 10 with a grill 12, is contemplated that the wedge device 10 is not limited to such application and can be used with many other applications in which it is desirable for a rotatable first object 14 to be spaced a predetermined distance from a fixed second object 16. As used herein, the term “open grill” means that at least a portion of the first object 14 has been rotated away from the second object 16, as can be seen in FIGS. 1 and 2.

In one aspect, the first object 14 can be a lid of the grill 12 and the fixed second object 16 can be a lower tub of the grill 12. The second object 16 can define a second interior chamber 20 having a second chamber volume. In one aspect, the second object 16 can have an upper edge 18 around an open upper end. The first object 14 can define a first interior chamber 21 having a first chamber volume. The first object 14 can have a lower edge 22 sized and shaped such that the lower edge 22 of the first object 14 can matingly engage the upper edge 18 of the second object 16 to enclose the first and second interior chambers 20, 21 when the first object 16 is in a closed position. Optionally, a sealing gasket 24 can be positioned on at least one of the upper edge 18 of the second object 16 and the lower edge 22 of the first object 14 to form a seal between the second object 16 and the first object 14 when the first object 14 is in the closed position.

For reference throughout this application, the “front” of the first object 14 and/or the second object 16 can have a handle 26 or other opening device, and the “rear” of the first object 14 and the second object 16 can be the opposed side from the front. For example, FIG. 1 shows the front of the first object 14 and the second object 16. The “left side” and the “right side” of the first object 14 and the second object 16 can extend between the front and the rear.

The wedge device 10 can be substantially arcuate or annular in shape with an opening 28 defined in a portion of a front 30 of the wedge 10. In one aspect, due to the opening 28 defined in the wedge 10, the wedge 10 can be substantially “C” shaped when viewed from above. In another aspect, the wedge 10 can comprise a first lower surface 32 extending for at least a portion of the circumferential length of the wedge 10. The lower surface 32 can have a first diameter configured to matingly engage the upper edge 18 of the second object 16. That is, the first lower surface 32 of the wedge 10 can be sized and shaped to be coupled to the upper edge 18 of the second object 16. In still another aspect, the wedge 10 can further comprise a second upper surface 34 extending for at least a portion of the circumferential length of the wedge 10. The upper surface 34 can have a second diameter configured to matingly engage the lower edge 22 of the first object 14. That is, the second upper surface 34 of the wedge 10 can be sized and shaped to be coupled to the lower edge 22 of the first object 14. In use, described more fully below, the wedge 10 can be positioned on the fixed second object 16 such that the lower surface 32 of the wedge 10 engages at least a portion of the upper edge 18 of the second object for the circumferential length of the wedge 10.

In one aspect, the opening 28 defined in the arcuate or annular wedge 10 can allow access to an inner volume of the wedge 10. That is, the opening 28 can place the inner volume of the wedge 10 in fluid communication with the environment located outside of the wedge 10. In another aspect, the opening 28 can have an opening width W₁. In this aspect, the opening width W₁ can be selected so that a desired item, such as food to be cooked, can be inserted into a third interior chamber 23 formed by the first interior chamber 21, the second interior chamber 22, and the inner volume of the wedge 10 through the opening 28 defined in the wedge 10.

When viewed from the side, as illustrated in FIG. 6, the wedge 10 can have a first wedge height H₁ at the front 30 of the wedge 10, and a second wedge height H₂ at a rear 36 of the wedge 10. In one aspect, the first wedge height H₁ can be greater than the second wedge height H₂ such that the height of the wedge 10 tapers from the front 30 of the wedge 10 towards the rear 36 of the wedge 10. In another aspect, the slope of the taper of can be constant so that in use and when the wedge 10 is positioned on the fixed second object 16, the lower edge 22 of the first object 14 can be positioned on the upper surface 34 of the wedge 10 for at least a portion of the circumferential length of the wedge 10. The first wedge height H₁ can be selected so that a desired item, such as food to be cooked, can be inserted into the third interior chamber 23 though the opening 28 defined in the wedge 10.

The wedge 10 can further comprise a heat-deflecting shield 38 coupled to or formed integrally with the upper surface 34 of the wedge 10. In one aspect, the heat-deflecting shield 38 can extend upward and away from the upper surface 34 at an obtuse angle α relative to the upper surface 34, as can be seen in FIG. 5. For example, the obtuse angle α can be about 100 degrees, 110 degrees, 120 degrees, 130 degrees, 135 degrees, 140 degrees, 150 degrees, 160 degrees, or about 170 degrees. The obtuse angle α can be constant along the circumferential length of the wedge 10. Optionally, however, at least a portion of the obtuse angle α can vary along the circumferential length of the wedge 10.

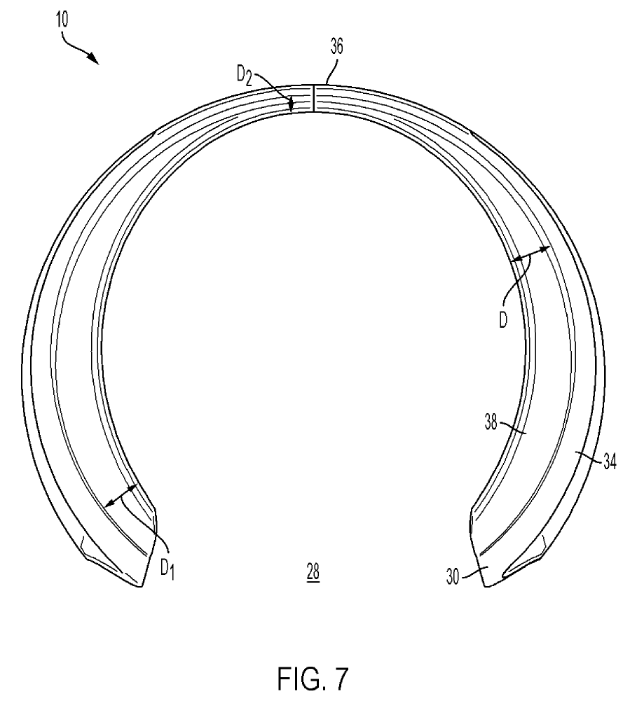

The heat-deflecting shield 38 can extend upward and away from the upper surface 34 of the wedge 10 for a predetermined distance D. In one aspect, the predetermined distance D can be constant along the circumferential length of the wedge 10. Optionally, however, at least a portion of the predetermined distance D can vary along the circumferential length of the wedge 10. For example, and as can be seen in FIG. 7, the heat-deflecting shield 38 can extend upward and away from the upper surface 34 of the wedge 10 for a first distance D₁ at the front 30 of the wedge 10, and a second distance D₂ at the rear 36 of the wedge 10. In this example, the first distance D₁ can be greater than the second distance D₂ such that the heat-deflecting shield 38 extends farther upward and away from the upper surface 34 at the front 30 of the wedge 10 than at the rear 36 of the wedge 10.

In one aspect, the wedge 10 can further comprise a plurality of positioning tabs 40 coupled to or formed integrally with the lower surface 32 of the wedge 10. In this aspect, the positioning tabs 40 can extend downward from the lower surface 32 of the wedge 10 and can be sized and shaped so that the positioning tabs 40 can engage an inner surface 42 of the second object 16. In use, the positioning tabs 40 can maintain the wedge 10 in a desired position relative to the second object 16. There can be, for example and without limitation, two, three, four, five, six or more than six positioning tabs 40. In one aspect, the positioning tabs 40 can be substantially evenly spaced around the perimeter of the wedge 10. Optionally, the positioning tabs 40 need not be substantially evenly spaced, and at least one positioning tab 40 can be spaced closer to a first adjacent positioning tab 40 than to a second adjacent positioning tab 40.

In one aspect, the wedge 10 can be formed from a single monolithic piece. Alternatively, the wedge 10 can be formed from two or more wedge segments coupled together to form the wedge device 10. For example, the wedge device 10 can comprise two wedge segments that can be coupled together by a user to form the wedge device 10. The wedge 10 can be formed from any appropriate durable structural material using any fabrication process. For example, stainless steel or another appropriate metal can be used to form the wedge 10. In another example, the wedge 10 can be formed from ceramic materials. Optionally, a rigid polymeric material such as nylon and the like can be used to from the wedge 10. As can be appreciated, the wedge 10 can be formed from any combination of these materials. The materials can be cut, bent, welded, molded, or otherwise formed in a conventional manner to form the components of the wedge device 10.

In use, the wedge 10 maintains the rotatable first object 14 in a desired position relative to the fixed second object 16. The first object 14 can rotate about and between the first, closed position (not shown), in which the lower edge 22 of the first object 14 engages the upper edge 18 of the second object 16, and the second, open position (as shown in FIG. 1), in which a front 43 of the first object 14 is spaced from the second object 16 a predetermined open distance. For example, if the first object 14 is a lid of a grill 12, the predetermined open distance can be large enough to allow a user to easily access the interior chamber 20 of the grill 12. In the second, open position, however, much heat could be lost from the grill 12.

In one aspect, with the first object 14 in the second, open position, the wedge 10 can be positioned onto the second object 16. For example, the first lower surface 32 of the wedge 10 can be positioned on and can matingly engage at least a portion of the upper edge 18 of the second object 16. If a sealing gasket 24 is present, in the gasket 24 can engage the lower surface 32 of the wedge 10. The opening 28 defined in a portion of a front 30 of the wedge 10 can be aligned with the front 44 of the second object 16. The positioning tabs 40 can engage the inner surface 42 of the second object 16 so that the wedge 10 is maintained in a desired position relative to the second object 16.

The first object 14 can then be rotated from the second, open position to a third, intermediate position (as shown in FIG. 2), in which the front 42 of the first object 14 is spaced from the second object 16 a predetermined intermediate distance that is less than the predetermined open distance. In the third, intermediate position, the wedge 10 can be positioned between the first object 14 and the second object 16. More specifically, in the third, intermediate position, at least a portion of the upper surface 34 of the wedge 10 can matingly engage the lower edge 22 of the first object 14, and/or a sealing gasket 24, if present. As can be seen in FIG. 2, in the third, intermediate position, the wedge 10 can maintain the rotatable first object 14 in the desired position relative to the stationary second object 16, while preventing or limiting heat loss except through the opening 28 defined in the wedge 10.

If the first object 14 and the second object 16 are components of a grill 12, food to be cooked, such as a pizza, can be inserted through the opening 28 and into the third interior chamber 23. In one aspect, inserting food through the opening 28 can limit heat loss when compared to inserting food by opening the lid of the grill 12 (as shown in FIG. 1). The heat-deflecting shield 38 can deflect at least a portion of the heat moving upwards from first interior chamber 20 back downwards toward the first interior chamber 20. Because more heat can escape from the front 30 of the wedge 10 than from the rear 36 of the wedge 10 (due to the opening 28), the heat-deflecting shield 38 can extend farther upward and away from the upper surface 34 at the front 30 of the wedge 10 than at the rear 36 of the wedge 10. That is, the first distance D₁ can be greater than the second distance D₂. Thus, more heat can be deflected by the heat-deflecting shield 38 at the front 30 of the wedge 10 than at the rear 36 of the wedge 10 so that the item to be cooked can be cooked more evenly than if the first distance D₁ was equal to or less than the second distance D₂.

Although several aspects of the invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims that follow, they are used only in a generic and descriptive sense, and not for the purposes of limiting the described invention.

What is claimed is:

1. A wedge that allows the selective holding of a rotatable first object in a desired position relative to a stationary second object, wherein the first object has a lower edge configured to matingly engage an upper edge of the second object, and wherein the first object is rotatable about and between a first, closed position in which the lower edge of the first object engages the upper edge of the second object, and a second, open position in which a front of the first object is spaced from the second object a predetermined open distance, the wedge comprising:
a first lower surface extending for a circumferential length of the wedge, the first lower surface configured to matingly engage the upper edge of the second object;
a second upper surface extending for the circumferential length of the wedge, the second upper surface configured to matingly engage the lower edge of the first object;
a heat-deflecting shield extending upward and away from the second upper surface at an obtuse angle relative to the second upper surface for a predetermined distance, wherein the predetermined distance varies along the circumferential length of the wedge;
wherein the wedge has a first wedge height at a front of the wedge, and a second wedge height at a rear of the wedge that is less than the first wedge height such that the height of the wedge tapers from the front of the wedge towards the rear of the wedge,
wherein an opening is defined in the front of the wedge, the opening having an opening width such that an interior volume of the wedge is accessible though the opening.

2. The wedge of claim 1, wherein the heat-deflecting shield extends upward and away from the upper surface a first distance at the front of the wedge, and a second distance at the rear of the wedge.

3. The wedge of claim 2, wherein the first distance is greater than the second distance such that the heat-deflecting shield extends farther upward and away from the upper surface at the front of the wedge than at the rear of the wedge.

4. The wedge of claim 3, wherein the wedge is arcuate in shape.

5. The wedge of claim 4, wherein the wedge is substantially “C” shaped when viewed from above.

6. The wedge of claim 4, further comprising a plurality of positioning tabs extending from the first lower surface, the positioning tabs sized and shaped so to engage an inner surface of the second object and maintain the wedge in a desired position relative to the second object.

7. The wedge of claim 4, wherein when the first lower surface is positioned onto the second object, the first object is rotatable from the second, open position to a third, intermediate position, in which the front of the first object is spaced from the second object a predetermined intermediate distance that is less than the predetermined open distance.

8. The wedge of claim 7, wherein in the third intermediate position, an interior chamber formed by the first object, the second object, and the wedge is accessible though the opening.

9. A method to selectively hold a rotatable first object in a desired position relative to a stationary second object such that an interior chamber formed by the first object and the second object is accessible, wherein the first object has a lower edge configured to matingly engage an upper edge of the second object, and wherein the first object is rotatable about and between a first, closed position in which the lower edge of the first object engages the upper edge of the second object, and a second, open position in which a front of the first object is spaced from the second object a predetermined open distance, the method comprising:
providing a wedge comprising:
a first lower surface extending for a circumferential length of the wedge, the first lower surface configured to matingly engage the upper edge of the second object;
a second upper surface extending for the circumferential length of the wedge, the second upper surface configured to matingly engage the lower edge of the first object;
a heat-deflecting shield extending upward and away from the second upper surface at an obtuse angle relative to the second upper surface for a predetermined distance, wherein the predetermined distance varies along the circumferential length of the wedge;
wherein the wedge has a first wedge height at a front of the wedge, and a second wedge height at a rear of the wedge that is less than the first wedge height such that the height of the wedge tapers from the front of the wedge towards the rear of the wedge;
wherein an opening is defined in the front of the wedge, the opening having an opening width such that an interior volume of the wedge is accessible though the opening;
positioning the first lower surface of the wedge onto the second object; and
rotating the first object from the second, open position to a third, intermediate position, in which the front of the first object is spaced from the second object a predetermined intermediate distance that is less than the predetermined open distance.

10. The method of claim 9, wherein the heat-deflecting shield extends upward and away from the upper surface a first distance at the front of the wedge, and a second distance at the rear of the wedge.

11. The method of claim 10, wherein the first distance is greater than the second distance such that the heat-deflecting shield extends farther upward and away from the upper surface at the front of the wedge than at the rear of the wedge.

12. The method of claim 11, wherein the wedge is arcuate in shape.

13. The method of claim 12, wherein the wedge is substantially “C” shaped when viewed from above.

14. The method of claim 12, further comprising a plurality of positioning tabs extending from the first lower surface, the positioning tabs sized and shaped so to engage an inner surface of the second object and maintain the wedge in a desired position relative to the second object.

15. The method of claim 12, wherein in the third intermediate position, an interior chamber formed by the first object, the second object, and the wedge is accessible though the opening.

16. A method for evenly cooking a desired food item in an open grill, the grill having a rotatable first object and a stationary second object, wherein the first object has a lower edge configured to matingly engage an upper edge of the second object, and wherein the first object is rotatable about and between a first, closed position in which the lower edge of the first object engages the upper edge of the second object, and a second, open position in which a front of the first object is spaced from the second object a predetermined open distance, the method comprising:
providing a wedge comprising:
a first lower surface extending for a circumferential length of the wedge, the first lower surface configured to matingly engage the upper edge of the second object;
a second upper surface extending for the circumferential length of the wedge, the second upper surface configured to matingly engage the lower edge of the first object;
a heat-deflecting shield extending upward and away from the second upper surface at an obtuse angle relative to the second upper surface for a predetermined distance, wherein the predetermined distance varies along the circumferential length of the wedge;
wherein the wedge has a first wedge height at a front of the wedge, and a second wedge height at a rear of the wedge that is less than the first wedge height such that the height of the wedge tapers from the front of the wedge towards the rear of the wedge,
wherein an opening is defined in the front of the wedge, the opening having an opening width such that an interior volume of the wedge is accessible though the opening;
positioning the first lower surface of the wedge onto the second object;
rotating the first object from the second, open position to a third, intermediate position, in which lower edge of the first object is positioned onto the second upper surface of the wedge;
inserting the food item through the opening into an interior chamber formed by the first object, the second object, and the wedge; and
heating the interior chamber with a heat source.

17. The method of claim 16, wherein the heat-deflecting shield extends upward and away from the upper surface a first distance at the front of the wedge, and a second distance at the rear of the wedge.

18. The method of claim 17, wherein the first distance is greater than the second distance such that the heat-deflecting shield extends farther upward and away from the upper surface at the front of the wedge than at the rear of the wedge.

19. The method of claim 18, wherein more heat is deflected by the heat-deflecting shield at the front of the wedge than by the heat-deflecting shield at the rear of the wedge.
